(19) United States
(12) Patent Application Publication
(10) Pub. No.: US 2005/0182942 A1
(43) Pub. Date: Aug. 18, 2005

(54) Methods and devices for obtaining domain access rights

(76) Inventor: Doru Calin, Manalapan, NJ (US)

Correspondence Address: HARNESS, DICKEY & PIERCE, P.L.C., P.O. Box 8910, Rexton, VA, 20195, US

(21) Appl. No.: 10/778,189

(22) Filed: Feb. 17, 2004

(51) Int. Cl. H04K 1/00

(52) U.S. Cl. 713/182

(57) ABSTRACT

Communication between devices participating in a teleconference or the like is maintained without the need for each device to separately obtain new domain access rights as one or more of the devices comes in contact with a new domain.

### BACKGROUND OF THE INVENTION

Today, when one or more participants in a teleconference move from one domain, e.g., a portion of one or more networks, into another domain with their associated wireless devices, a teleconference can be maintained only if each of the devices obtains its own access rights, e.g., authentication, authorization and accounting (AAA) rights, from the new domain.

### SUMMARY OF THE INVENTION

The problem associated with existing techniques are overcome in accordance with the principles of the present invention by allowing domain access rights associated with a new domain to be obtained by only one participant in a teleconference on behalf of all other participants. In one exemplary embodiment of the present invention, this is achieved by obtaining, at a first node, e.g., wireless device, access rights from a domain and broadcasting the obtained access rights to at least one other node provided the first node has also previously obtained a right to broadcast the access rights.

### BRIEF DESCRIPTION OF THE DRAWINGS

FIG. 1 depicts a simplified diagram of a plurality of nodes carrying out a teleconference while one or more of the nodes are moving from one domain to another according to one embodiment of the present invention.

FIG. 2 depicts a plurality of nodes carrying out a teleconference while multiple nodes are moving from one domain to another according to yet another embodiment of the present invention.

### DETAILED DESCRIPTION OF THE INVENTION

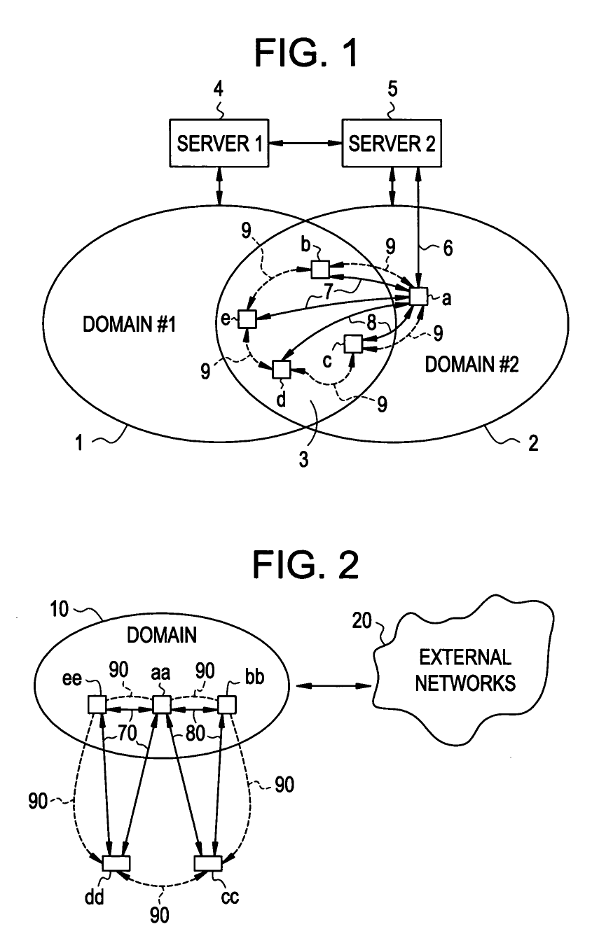

Referring now to FIG. 1, there is shown nodes a-e which form a plurality of nodes interconnected in a teleconference via pathways 9 shown by the dotted lines in FIG. 1. Obviously, multiple connectivity patterns are possible between the nodes belonging to the group. Thus, the connection pattern 9 shown in FIG. 1 is just one of a number of possible examples. As each of the nodes a-e moves from a first domain 1 to a second domain 2, it is necessary that each node receive the proper access rights from a server 5 associated with the second domain 2. In one embodiment of the present invention, unlike existing techniques, it is not necessary for each of the nodes a-e to separately request access rights in order to receive such rights. Instead, all that is required is for a single node to request and obtain access rights (e.g., authentication, authorization and accounting rights) from the second domain 2. Once the node obtains these rights it is allowed to access the second domain 2. In addition, thereafter, the node is operable to broadcast these rights to other interconnected nodes as long as it has a right to broadcast (e.g., it is a master node; see below). It should be noted that all of the nodes a-e need not be wireless devices. Some of the nodes a-e may be moving, wired devices. That is, some of the nodes may be capable of moving from one domain to another using wireless antennas while others may be connected or hard-wired to a movable unit (e.g., a mobile communications vehicle used in military, police, fire or emergency situations). Similarly, some may be capable of receiving radio frequency signals while others may not be. According to the present invention, it is important that, regardless of whether or not all of the nodes a-e or just some of the nodes a-e are wireless devices, none of the nodes or devices a-e are dropped from a teleconference or the like as a particular node/device moves from one domain to another (i.e., they are not involuntarily dropped). In addition, the number of nodes within the group may change. Some nodes may be added; some nodes may voluntarily exit; some nodes may first exit and then reenter the teleconference. As is recognized by those skilled in the art, when a node a-e is operating using wireless technology, and that node becomes disconnected, it is necessary for the node which has become disconnected to be in the coverage area of at least one of the initial participating nodes or in the coverage area of at least one presently participating node to be re-connected.

In this manner, each of the nodes a-e need not request its own, separate access rights in order to continue to carry out communications between the remaining nodes participating in the teleconference as one or more of the nodes move from one domain to another. This significantly reduces the amount of bandwidth necessary to carry out such a teleconference or the like and the time necessary to set up such a teleconference. It also reduces the complexity of the signaling and security mechanisms needed to initiate, maintain and secure such a teleconference or the like.

Suppose node a is the first node to move from domain 1 to domain 2 as shown in FIG. 1. For reference purposes, node a will be referred to as a “first” node because it is the first node to move from one domain to another. It should be understood that although it is node a which is shown as the first node in FIG. 1, that any one of the other nodes b-e may be the first node to move from one domain to another.

Depending on the designation given to node a (to be explained below), node a may immediately obtain access rights from the second domain 2 and broadcast these access rights to at least one other interconnected node b-e. This will be the case if node a has previously been designated as a so-called “master” node. As a master node, node a has previously obtained or been given the capability to broadcast access rights to other nodes. Without such a capability, node a may not be able to broadcast access rights at all. If, however, node a has not been designated a master node prior to moving from the first domain 1 into the second domain 2, its designation when it first moves into the second domain 2 will be as a so-called “slave” node. In such a case, the present invention provides for one of many options.

First, node a may be declared a master node and be given (or permitted to obtain) a right to broadcast, thereby setting up two master nodes (at least temporarily) within the group of interconnected nodes a-e. If this occurs, the existing master node may be declared a slave node thereby eliminating duplicate master nodes or may remain a master node. In the latter case, the existing master node may go further and broadcast instructions to the remaining interconnected slave nodes to prevent them from accessing information with the new, second domain 2.

In more detail, each of the nodes a-e has the ability to declare itself a master or slave node by, for example, obtaining or failing to obtain, a right to broadcast. In the time substantially immediately after the first node a moves into the second domain 2 and obtains access rights, the first node a may exchange messages with an existing master node (assuming node a is not such a node). The first node a and the master node may exchange information which can be used by one or both of them to determine whether they should declare themselves (or be declared as) a master or slave node.

In yet a further embodiment of the present invention, if the first interconnected node a is not a master node at the time it comes in contact with the second domain 2, and chooses not to become a master node of the present interconnected group of nodes a-e, or cannot become a master node, first node a may be disconnected (or disconnect itself) from the other interconnected nodes b-e. In such a case, the first node a may decide to join another group or proceed to operate within the second domain on an individual basis (i.e., it may choose to join another teleconference or leave the teleconference altogether).

Backtracking somewhat, there are reasons why an existing master node may deem it necessary to prevent other interconnected slave nodes from accessing a second domain 2. For example, the master node may determine that it is not possible or efficient for the remaining interconnected nodes to access the second domain 2 in which case it may send a message to the remaining interconnected slave nodes to keep them connected to the first domain 1 or to delay their access to the second domain 2.

Having presented a number of options, we now focus on those options where the interconnected nodes b-e receive broadcasted access rights to enable them to access the second domain 2. In such a case, it can be seen that the amount of communications needed between each of the nodes a-e and the second server 5 and between the second server 5 and the first server 4 associated with the first domain 1 may be reduced.

For example, instead of exchanging authentication and authorization information about each of the nodes a-e, the servers 4 and 5 need only exchange information about the first node a.

The interconnected nodes a-e may form one or more networks, such as a iDEN network, a 3G network or any other wireless network that allows group based communications (e.g., radio access may be Code Division Multiple Access (CDMA) based, Time Division Multiple Access (TDMA) based or based on any other radio access technology), a Bluetooth network, a 4G network, to name just a few. In general, any wired, wireless, ad-hoc or converged (combination of networks) network that supports interconnected devices may be used.

Before going further it should be noted that the phrase “teleconference” is meant to include the exchange of voice-, video-, text-, or image-based messages (to give a few examples) by interconnected nodes.

Up to now the discussion has centered on the operation of first node a. It should be understood that each of the other nodes b-e are also operable to receive the access rights broadcast by the first node a or a master node which has received access rights, from node a for example, (hereafter “authorized master node”) in order to allow the nodes b-e to access the domain 2.

In a further embodiment of the present invention, the first node a or an authorized master node may only broadcast access rights to some of the slave nodes. In this case, only those nodes which receive the access rights are allowed to access domain 2.

In yet a further embodiment of the present invention, the first node a or an authorized master node may be operable to only broadcast information, not access rights, from the second domain 2 to other nodes within a network. In other words, suppose some of the nodes b-e are not granted access rights. Nevertheless, it is desirable to broadcast information (e.g., data other than access rights) from the second domain 2 to the unauthorized and unauthenticated nodes b-e, that belong to the same group that the first node, node a, belongs to. The present invention envisions such a scenario and allows information to be broadcast from the second domain 2 via the first node a or authorized master node to unauthorized nodes b-e. It can be said that the first node a and/or an authorized master node acts as a trusted gateway to forward information to the unauthorized nodes b-e.

Referring now to FIG. 2, there is shown another embodiment of the present invention. Here, more than one first node aa, bb, ee is shown moving into contact with a domain 10. These first nodes aa, bb, ee may be more complex than the remaining nodes cc, dd. Nodes aa, bb, ee may be capable of decoding (e.g., decrypting) information. That is to say, nodes cc, dd may not be equipped to decode messages from the domain 10 even if these nodes are authorized and authenticated to access domain 10.

In one embodiment of the present invention, at least one of the first nodes aa, bb, ee is operable to obtain access rights from the domain 10 in order to access domain 10. As shown, each of the three first nodes aa, bb, ee obtains access rights from the domain 10. Thereafter, each of these nodes aa, bb, ee may act as a first node a or as a master node as described above to broadcast the access rights to the remaining nodes cc, dd (provided, of course, they also have obtained a right to broadcast). Alternatively, as in FIG. 1, each of the nodes aa, bb, ee may be further operable to only broadcast information, not access rights, to each of the nodes cc, dd.

After obtaining access rights, first nodes aa, bb, ee may be operable to decode/decrypt information sent from domain 10. In sum, it is not necessary for the slave nodes cc, dd to either obtain access rights to domain 10 or be capable of decoding information as long as a first node aa, bb or ee has such rights and capabilities. Decryption just by certain nodes allows communications to be secure without the need to provide each of the interconnected nodes with an encryption/decryption capability. This not only saves costs but reduces bandwidth requirements while providing more secure communications.

The discussion above has sought to present some examples of how the present invention obtains and controls the broadcast of access rights as one or more nodes moves from one domain to another. However, the scope of the present invention is better defined by the claims which follow.

1. A method for providing access rights to a domain comprising the steps of:
obtaining, at a first node, access rights from a domain; and
broadcasting, by the first node, the obtained access rights to at least one other node when the first node has a right to broadcast.

2. The method as in claim 1 further comprising the steps of:
obtaining, at said first node, a right to broadcast when said first node does not have the right to broadcast; and
broadcasting the obtained access rights to at least one other node after obtaining the right to broadcast.

3. The method as in claim 1 wherein said first node has obtained the right to broadcast before obtaining said access rights.

4. The method as in claim 1 wherein the first node comprises a wireless device.

5. The method as in claim 1 wherein the first node comprises a wired device.

6. The method as in claim 1 wherein the access rights are selected from the group consisting of at least authentication, authorization and accounting rights.

7. The method as in claim 1 further comprising the step of:
receiving the broadcasted access rights, by at least one other node, to allow the at least one other node to access the domain.

8. The method as in claim 1 further comprising the steps of:
decoding, at the first node, information from the domain; and
broadcasting the decoded information to at least one other node.

9. The method as in claim 1 further comprising the step of broadcasting, by the first node, information from the domain to at least one other node.

10. The method as in claim 9 further comprising the step of receiving the broadcasted information by the at least one other node.

11. A device for providing access rights to a domain, the device operable to:
obtain access rights from a domain; and
to broadcast the obtained access rights to at least one node, when the device has a right to broadcast.

12. The device as in claim 11 further operable to:
obtain a right to broadcast; and
broadcast the obtained access rights to at least one node after obtaining the right to broadcast.

13. The device as in claim 11 further operable to obtain a right to broadcast before obtaining said access rights.

14. The device as in claim 11 wherein the device comprises a wireless device.

15. The device as in claim 11 wherein the device comprises a wired device.

16. The device as in claim 11 wherein the access rights are selected from the group consisting of at least authentication, authorization and accounting rights.

17. The device as in claim 11 further operable to:
decode information from the domain; and
broadcast the decoded information to at least one node.

18. The device as in claim 11 further operable to broadcast information from the domain to at least one node.

19. A device for providing access rights to a domain comprising:
means for obtaining access rights from a domain; and
means for broadcasting the obtained access rights to at least one node when the device has a right to broadcast.

20. The device as in claim 19 further comprising:
means for obtaining a right to broadcast, and
means for broadcasting the obtained access rights after obtaining the right to broadcast.

21. The device as in claim 19 further operable to obtain the right to broadcast before obtaining said access rights.

22. The device as in claim 19 further comprising means for:
decoding information from the domain; and
broadcasting the decoded information to at least one node.

23. The device as in claim 19 further comprising means for broadcasting information from the domain to at least one node.
